(19) United States
(12) Patent Application Publication
(10) Pub. No.: US 2013/0056459 A1
(43) Pub. Date: Mar. 7, 2013

(54) MICROWAVE OVEN

(71) Applicants: Gyu-Sik LIM, Suwon-si (KR); Tae Kyou Park, Hwaseong-si (KR); Yong Sung Choi, Yongin-si (KR); Won Woo Choi, Anyang-si (KR)

(72) Inventors: Gyu-Sik LIM, Suwon-si (KR); Tae Kyou Park, Hwaseong-si (KR); Yong Sung Choi, Yongin-si (KR); Won Woo Choi, Anyang-si (KR)

(73) Assignee: Samsung Electronics Co., Ltd., Suwon (KR)

(21) Appl. No.: 13/602,877

(22) Filed: Sep. 4, 2012

(30) Foreign Application Priority Data
Sep. 7, 2011 (KR) 10-2011-0090868

(51) Int. Cl. H05B 6/66

(52) U.S. Cl. 219/702

(57) ABSTRACT

A microwave oven capable of quickly detecting the abnormal operation and the overheated temperature of a high voltage transformer. The microwave oven including cooking chamber, a magnetron configured to provide a high frequency wave to inside of the cooking chamber, a high voltage transformer (HVT) including a core, a primary coil wound around the core, and a secondary coil wound around the core and configured to transform a voltage, which is provided to the microwave oven, to the magnetron, and a Thermo Protector (TP) configured to block a current from being applied to the primary coil when the HVT is overheated, wherein the TP is disposed at an outer surface of the secondary coil.

### CROSS-REFERENCE TO RELATED APPLICATIONS

This application claims the benefit of Korean Patent Application No. 2011-0090868, filed on Sep. 7, 2011 in the Korean Intellectual Property Office, the disclosure of which is incorporated herein by reference.

### BACKGROUND

1. Field

Embodiments of the present disclosure relate to a Thermo Protector (TP) to protect a high voltage transformer (HVT) of a microwave oven.

2. Description of the Related Art

A microwave oven is an apparatus that cooks food by use of a frictional heat generated by vibration of water molecules occurred in the food when microwave is radiated to the food.

A magnetron driving circuit of the microwave oven includes a high voltage transformer (HVT), a high voltage diode, a high voltage capacitor, and a magnetron.

The high voltage transformer (HVT) allows an alternating current (AC) voltage to be stepped up or stepped down. The high voltage transformer includes a primary coil to receive an alternating current (AC) power, a secondary coil to provide a high voltage, and a filament coil to provide a low voltage.

A high voltage is rectified by the high voltage diode and is raised by the high voltage capacitor. The magnetron is heated by receiving a low voltage and generates high frequency waves by receiving a direct high voltage from the high voltage diode and from the high voltage capacitor.

Meanwhile, a Thermo Protector (TP) used to protect the HVT is attached between a core and a secondary coil to detect the overheated temperature upon abnormal operation caused by coil damage, such as coil cutting, the inferiority of coil alignment, and the inferiority of component coupling during the interior work such that a power source is blocked from being supplied to the primary coil to prevent overcurrent and fire.

However, such a conventional TP is inefficient in quickly detecting the overheated temperature under the abnormal operation caused by its attachment position and fixing configuration, resulting in a fire.

### SUMMARY

Therefore, it is an aspect of the present disclosure to provide a microwave oven capable of quickly detecting the abnormal operation and the overheated temperature of a high voltage transformer by improving the installment position and the fixing configuration of a Thermo Protector (TP).

It is an additional aspect of the present disclosure to provide a microwave oven capable of preventing a high voltage transformer from being damaged by use of a Thermo Protector (TP), thereby improving durability of the microwave oven.

Additional aspects of the disclosure will be set forth in part in the description which follows and, in part, will be obvious from the description, or may be learned by practice of the disclosure.

In accordance with one aspect of the present disclosure, a microwave oven includes a cooking chamber, a magnetron, a high voltage transformer (HVT), and a Thermo Protector (TP). The magnetron is configured to provide a high frequency wave to inside of the cooking chamber. The high voltage transformer (HVT) includes a core, a primary coil wound around the core, and a secondary coil wound around the core and configured to transform a voltage, which is provided to the microwave oven, to the magnetron. The thermo Protector (TP) is configured to block a current from being applied to the primary coil when the HVT is overheated. The TP is disposed at an outer surface of the secondary coil.

The TP is attached to a center of the outer surface of the secondary coil.

The microwave oven further includes a fixing holder configured to fix the TP.

The fixing holder includes a fixing part, which makes contact with the secondary coil such that the TP is fixed to an outer side of the secondary coil, and a support part, which extends from the fixing part and makes contact with an outer surface of the TP.

The support part includes a reinforcing rib protruding inward of the support part such that the TP comes into close contact with the secondary coil.

The fixing holder includes insulating material.

The HVT is impregnated with varnish solution, and the TP is attached to the secondary coil through the fixing holder and the impregnation of the HVT with the varnish solution.

The HVT includes an insulating tape, and the TP is fixed to the secondary coil using the fixing holder and the insulating tape.

An insulating sheet is provided between the TP and the secondary coil, or is provided at an outer circumference of the TP and the secondary coil.

The HVT is impregnated with varnish solution, and the TP is attached to the secondary coil through the insulating sheet and the impregnation of the HVT with the varnish solution.

One end of the TP is connected to the primary coil and the other end of the TP is connected to the secondary coil.

In accordance with another aspect of the present disclosure, a microwave oven includes a cooking chamber, a magnetron, a high voltage transformer (HVT), and a Thermo Protector (TP). The magnetron is configured to provide a high frequency wave to inside the cooking chamber. The high voltage transformer (HVT) includes a core, a primary coil wound around the core, and a secondary coil wound around the core and configured to transform a voltage, which is provided to the microwave oven, to the magnetron.

The Thermo Protector (TP) is configured to block a current from being applied to the primary coil when the HVT is overheated.

The fixing holder includes a fixing part ,which makes contact with the secondary coil, a support part, which extends from the fixing part and makes contact with an outer surface of the TP, and a reinforcing rib protruding inward of the support part.

The fixing holder is attached to a center of an outer surface of the secondary coil.

The HVT is impregnated with varnish solution, and the TP is attached to the secondary coil through the fixing holder and the impregnation of the HVT with the varnish solution.

The microwave oven further includes an insulating sheet provided between the TP and the secondary coil or provided at an outer circumference of the TP and the secondary coil, wherein the TP is attached to the secondary coil through the insulating sheet and the impregnation of the HVT with the varnish solution.

The HVT includes an insulating tape, and the TP is fixed to the secondary coil through the fixing holder and the insulating tape.

As described above, the abnormal operation and the overheated temperature of a high voltage transformer are quickly detected, and thus a Product Liability (PL)-related accident caused by smoke and fire is prevented.

The installment position and the fixing configuration of a Thermo Protector (TP) are improved to prevent a high voltage transformer from being damaged, thereby improving the durability of a microwave oven.

In accordance with another aspect of the present disclosure , a method for protecting a microwave oven from being overheated including: providing e a high frequency wave to inside of the cooking chamber using a high voltage transformer (HVT), which comprises a core, a primary coil wound around the core, and a secondary coil wound around the core and configured to transform a voltage, which is provided to the microwave oven, to the magnetron; detecting the HVT is overheated; activating a Thermo Protector (TP) to block a current from being applied to the primary coil if the HVT is overheated, wherein the TP is disposed at an outer surface of the secondary coil.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view schematically illustrating a microwave oven according to an embodiment of the present disclosure.

FIG. 2 is a perspective view schematically illustrating a microwave oven having a Thermo Protector (TP) according to an embodiment of the present disclosure.

FIG. 3 is a perspective view schematically illustrating a high voltage transformer (HVT) having a Thermo Protector (TP) according to an embodiment of the present disclosure.

FIG. 4 is an exploded perspective view schematically illustrating a high voltage transformer (HVT) having a Thermo Protector (TP) according to an embodiment of the present disclosure.

FIG. 5 is a perspective view schematically illustrating a Thermo Protector (TP) according to an embodiment of the present disclosure.

FIG. 6 is a schematic view of a simulation result showing the overheated temperature with the position of a Thermo Protector (TP) according to an embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

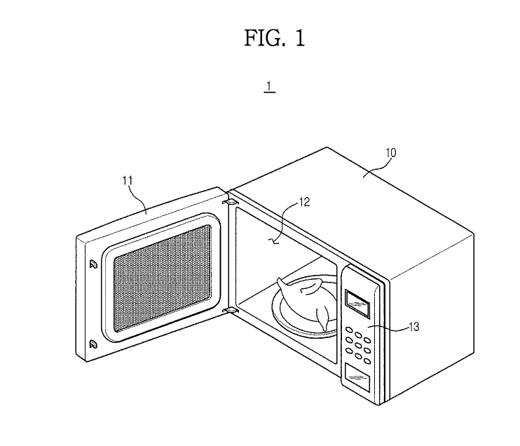

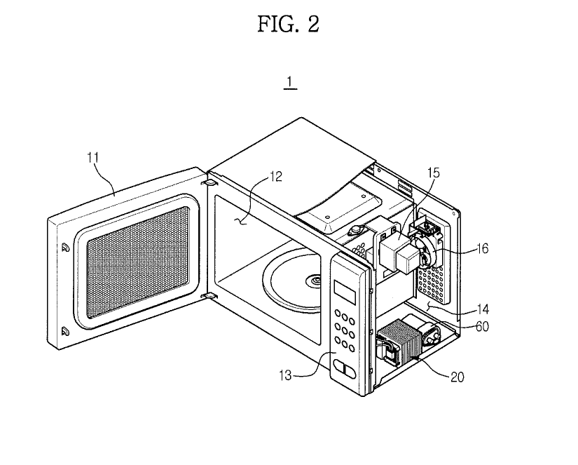

Referring to FIGS. 1 and 2, a microwave oven 1 includes a body 10 accommodating a cooking chamber 12 and a door 11 opening and closing a front surface of the body 10.

A control panel 13 having a plurality of operation buttons (not shown) is provided on one side of the door 11 to control various functions of the microwave oven 1.

A tray (not shown) is installed inside the cooking chamber 12 to have food placed thereon. A machine chamber 14 is provided on one side of the cooking chamber 12.

A magnetron 15, a high voltage transformer 20, and a high voltage capacitor 60 are installed in the machine chamber 14. The magnetron 15 is configured to generate high frequency waves. The high voltage transformer 20 and the high voltage capacitor 60 are configured to raise a voltage to a high voltage and to provide the high voltage to the magnetron 15.

In addition, a fan 16 is installed on a rear side of the machine chamber 14 to dissipate heat from components of the machine chamber 14.

The high voltage transformer 20 is provided with a core 21, including a plurality of iron cores stacked up against one another. A primary coil 22 and a secondary coil 23 are wound around the core 21.

A Thermo Protector (TP) 30 is provided to detect the overheated temperature under the abnormal operation caused by coil damage, such as coil cutting, the inferiority of coil alignment, and the inferiority of component coupling that may occur during the movement or the interior work, such that a power source is blocked from being supplied to the primary coil 22.

The TP 30 may include a bimetal configured to block a current from being applied to the primary coil 22 of the high voltage transformer 20 when high temperature of heat is generated from the high voltage transformer 20 due to overcurrent.

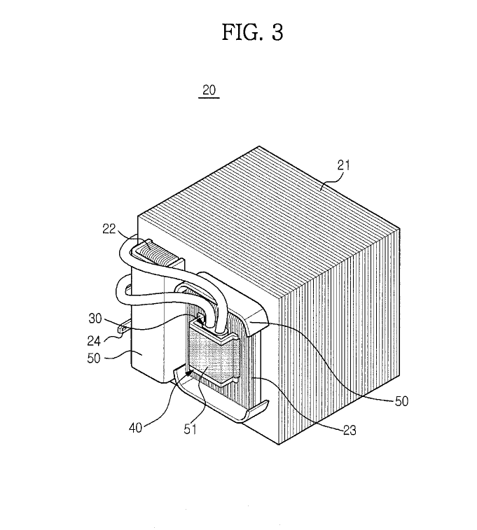

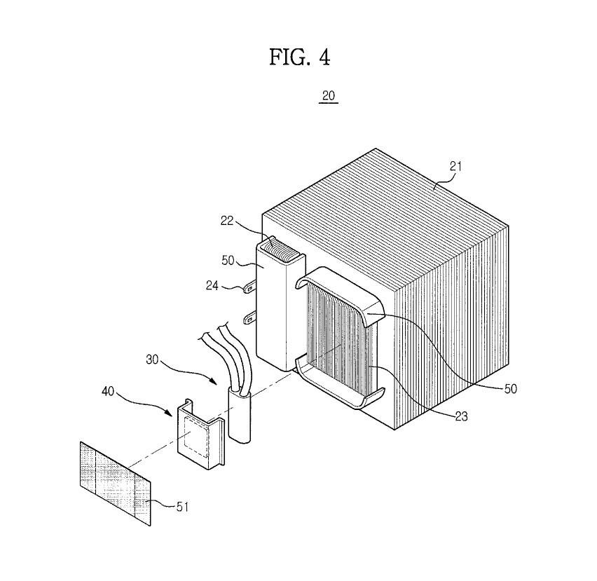

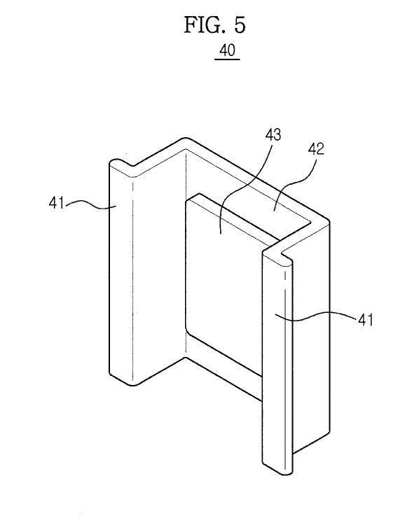

Referring to FIGS. 3 to 5, the high voltage transformer 20 is provided with an E-type core (not shown) and an I-type core (not shown). The primary coil 22 and the secondary coil 23 are inserted between the E-type core and the I-type core to generate a high voltage (see FIGS. 3 to 5).

The primary coil 22 is provided at one end thereof with a connection end 24 that make a connection with the magnetron 15. The secondary coil 23 is connected to the high voltage capacitor 60.

Each of the outer side of the primary coil 22 and the secondary coil 23 is surrounded by an insulating sheet 50, and is fixed to the insulting sheet 50 through adhesion material. The insulating sheet 50 includes a resin having electric insulation property and a heat resistance property.

One end of the TP 30 is connected to the primary coil 22, and the other end of the TP 30 makes contact with an outer surface of the secondary coil 23.

In order to quickly detect overheated heat generated from the high voltage transformer 20, the TP 30 is disposed at the outer surface of the secondary coil 23. When high temperature of heat is generated from the primary coil 22 and the secondary coil 23, the TP 30 quickly detects the overheating at the outer side of the secondary coil 23 and blocks a current from being provided to the high voltage transformer 20.

In this case, the TP 30 may be attached to the center of the outer surface of the secondary coil 23.

In addition, a fixing holder 40 is provided to securely fix the TP 30 to the secondary coil 23.

The fixing holder 40 includes a fixing part 41, which makes a direct contact with the outer surface of the secondary coil 23, and a support part 42 extending from the fixing part 41.

The fixing part 41 includes two parts that are spaced apart from each other by an interval in parallel to each other. The interval may correspond to the width of the TP 30.

The support part 42 connecting the two parts of the fixing part 41 to each other is configured to make contact with the outer surface of the TP 30. A reinforcing rib 43 protruding inward of the support part 42 allows the TP 30 to come into close contact with the outer surface of the secondary coil 23.

The reinforcing rib 43 may be provided in various thicknesses, sizes, and shapes depending on the TP 30.

The fixing holder 40 may include insulting material such that the TP 30 quickly detects the overheated temperature.

The TP 30 and the fixing holder 40 are fixed to the secondary coil 23 by an insulating tape 51 that is provided to wrap the outer surface of the TP 30 and the fixing holder 40.

The insulating sheet 50 is provided between the TP 30 and the secondary coil 23 and is provided at the outer circumference of the TP 30. When the TP 30 and the fixing holder 40 are fixed, the TP 30 and the fixing holder 40 are fixed together with the insulating sheet 50.

The high voltage transformer 20 is impregnated with varnish solution after assembly process. The TP 30 is impregnated while having the insulating sheet 50 and the insulating tape 51 attached thereto such that the TP 30 is hardened with the varnish solution while being attached to the high transfer transformer 20 and thus is installed and fixed to the high voltage transformer 20.

That is, the TP 30 is attached to the secondary coil 23 while being supported by the fixing holder 40, and then is impregnated with varnish solution such that the TP 30 is hardened with the varnish solution and thus fixed to the secondary coil 23. Alternatively, the TP 30 is attached to the secondary coil 23 by the insulating sheet 50, and then is impregnated with varnish solution such that the TP 30 is hardened with the varnish solution and thus fixed to the secondary coil 23. Alternatively, the TP 30 is attached to the secondary coil 23 together with the fixing holder 40 by use of the insulating tape 51, and then is impregnated with varnish solution such that the TP 30 is hardened with the varnish solution and thus fixed to the secondary coil 23. Preferably, the TP 30 is fixed by the insulating sheet 50 and the insulating tape 51, and then is impregnated with varnish solution such that the TP 30 is hardened with the varnish solution and thus fixed to the outer surface of the secondary coil 23.

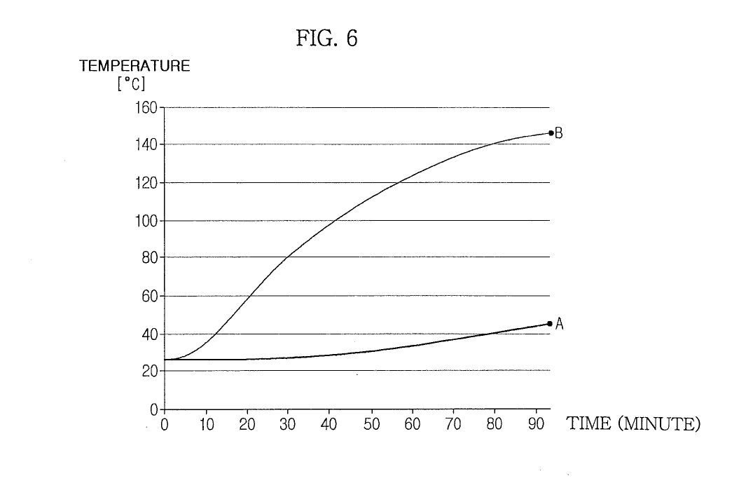

FIG. 6 is a schematic view of a simulation result showing the overheated temperature with the position of a Thermo Protector (TP) according to an embodiment of the present disclosure.

When it is assumed, in a case A, that the TP 30 is attached between a conventional core and the secondary coil 23 and in a case B that the TP 30 is attached to the outer surface of the secondary coil 23 through the fixing holder 40, the case A and the case B are simulated for detecting the overheated temperature during a time of one and a half hours (ninety minutes).

According to the result of simulation, the case A shows an overheated temperature of 43° C., and the case B shows an overheated temperature of 146° C., exhibiting a difference of 100° C. or above in the overheated temperature.

As shown in the simulation result, the overheated temperature is more quickly detected in the case where the TP 30 is attached on the outer surface of the secondary coil 23 through the fixing holder 40.

Hereinafter, the operation of the microwave oven 1 having the above configuration is described.

The microwave oven 1 obtains an electrostatic capacity from an electric current applied to the high voltage capacitor 60, and electric charges obtained from the high voltage capacitor 60 are applied to the high voltage transformer 20.

In the high voltage transformer 20, a voltage is raised as the current applied from the high voltage capacitor 60 passes through the primary coil 22 and the secondary coil 23, and the raised voltage is applied to the magnetron 15. The magnetron 15 provides the cooking chamber 12 with a high frequency wave of about 2450 MHz to cook the food inside the cooking chamber 12 according to an aspect of the embodiment.

If the temperature of the high voltage transformer 20 increases to a dangerous stage or an overheating occurs in the high voltage transformer 20 due to various abnormal conditions, the TP 30 attached to the outer surface of the secondary coil 23 quickly detects the overheating temperature and blocks the electric current provided to the high voltage transformer 20, thereby preventing a fire from starting on the high voltage transformer 20.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A microwave oven comprising:
a cooking chamber;
a magnetron configured to provide a high frequency wave to inside of the cooking chamber;
a high voltage transformer (HVT) comprising a core, a primary coil wound around the core, and a secondary coil wound around the core and configured to transform a voltage, which is provided to the microwave oven, to the magnetron; and
a Thermo Protector (TP) configured to block a current from being applied to the primary coil when the HVT is overheated,
wherein the TP is disposed at an outer surface of the secondary coil.

2. The microwave oven of claim 1, wherein the TP is attached to a center of the outer surface of the secondary coil.

3. The microwave oven of claim 1, further comprising a fixing holder configured to fix the TP.

4. The microwave oven of claim 3, wherein the fixing holder comprises a fixing part, which makes contact with the secondary coil such that the TP is fixed to an outer side of the secondary coil, and a support part, which extends from the fixing part and makes contact with an outer surface of the TP.

5. The microwave oven of claim 4, wherein the support part comprises a reinforcing rib protruding inward of the support part such that the TP comes into close contact with the secondary coil.

6. The microwave oven of claim 3, wherein the fixing holder includes insulating material.

7. The microwave oven of claim 3, wherein the HVT is impregnated with varnish solution, and
the TP is attached to the secondary coil through the fixing holder and the impregnation of the HVT with the varnish solution.

8. The microwave oven of claim 3, wherein the HVT comprises an insulating tape, and the TP is fixed to the secondary coil through the fixing holder and the insulating tape.

9. The microwave oven of claim 1, wherein an insulating sheet is provided between the TP and the secondary coil, or is provided at an outer circumference of the TP and the secondary coil.

10. The microwave oven of claim 9, wherein the HVT is impregnated with varnish solution, and
the TP is attached to the secondary coil through the insulating sheet and the impregnation of the HVT with the varnish solution.

11. The microwave oven of claim 1, wherein one end of the TP is connected to the primary coil and the other end of the TP is connected to the secondary coil.

12. A microwave oven comprising:
a cooking chamber;
a magnetron configured to provide a high frequency wave to inside the cooking chamber;
a high voltage transformer (HVT) comprising a core, a primary coil wound around the core, and a secondary coil wound around the core and configured to transform a voltage, which is provided to the microwave oven, to the magnetron;
a Thermo Protector (TP) configured to block a current from being applied to the primary coil when the HVT is overheated; and
a fixing holder configured to fix the TP to an outer side of the secondary coil.

13. The microwave oven of claim 12, wherein the fixing holder comprises a fixing part, which makes contact with the secondary coil, a support part, which extends from the fixing part and makes contact with an outer surface of the TP, and a reinforcing rib protruding inward of the support part.

14. The microwave oven of claim 12, wherein the fixing holder is attached to a center of an outer surface of the secondary coil.

15. The microwave oven of claim 12, wherein the HVT is impregnated with varnish solution, and
the TP is attached to the secondary coil through the fixing holder and the impregnation of the HVT with the varnish solution.

16. The microwave oven of claim 15, further comprising an insulating sheet provided between the TP and the secondary coil or provided at an outer circumference of the TP and the secondary coil, wherein
the TP is attached to the secondary coil through the insulating sheet and the impregnation of the HVT with the varnish solution.

17. The microwave oven of claim 12, wherein the HVT comprises an insulating tape, and
the TP is fixed to the secondary coil through the fixing holder and the insulating tape.

18. A method for protecting microwave oven from being overheated comprising:
providing e a high frequency wave to inside of the cooking chamber using a high voltage transformer (HVT), which comprises a core, a primary coil wound around the core, and a secondary coil wound around the core and configured to transform a voltage, which is provided to the microwave oven, to the magnetron;
detecting the HVT is overheated;
activating a Thermo Protector (TP) to block a current from being applied to the primary coil if the HVT is overheated,
wherein the TP is disposed at an outer surface of the secondary coil.
